(19) United States
(12) Patent Application Publication
(10) Pub. No.: US 2021/0108489 A1
(43) Pub. Date: Apr. 15, 2021

(54) MULTI-SOURCE ELECTRIC FRACTURING AND RESERVE POWER

(71) Applicant: Schlumberger Technology Corporation, Sugar Land, TX (US)

(72) Inventor: Rod William Shampine, Houston, TX (US)

(21) Appl. No.: 17/066,592

(22) Filed: Oct. 9, 2020

Related U.S. Application Data
(60) Provisional application No. 62/912,732, filed on Oct. 9, 2019.

(51) Int. Cl. E21B 41/00; E21B 43/26

(52) U.S. Cl. CPC E21B 41/0085; H02K 7/1823; E21B 43/2607

(57) ABSTRACT

A technique facilitates startup power and/or reserve power at an electric frac wellsite. An energy storage system, e.g. a battery bank, may be coupled with corresponding equipment and mounted on a transport for delivery to a desired wellsite. Additionally, the energy storage system may be coupled with a transformer which may be mounted on the same or a different trailer or skid. The energy storage system is configured to provide sufficient power for enabling turbine generator start up and/or provision of reserve power for other wellsite activities. In some embodiments, the energy storage system may be used to provide reserve power useful for improving operation of electric fracturing systems and for reducing the risk of wellsite shut down and cleanout.

### CROSS-REFERENCE TO RELATED APPLICATION

The present document is based on and claims priority to U.S. Provisional Application Ser. No. 62/912,732, filed Oct. 9, 2019, which is incorporated herein by reference in its entirety.

### BACKGROUND

In many well applications, fracturing services are conducted to improve production performance. Fracturing a well involves operating fracturing pumps to pump fracturing fluid downhole into a well under pressure. In the field of electric fracturing, large power levels, e.g. 30 MW, often are provided by a single large turbine generator or by multiple smaller turbine generators operated in parallel. In both cases, the turbine generators are not self starting, and a “black start” generator is used for starting the turbine generators. The “black start” generator often is diesel powered and adds footprint at the wellsite. As a result, diesel fuel must be provided on-site and the additional generator adds footprint while having limited usefulness in addition to startup. Another challenge at electric frac sites is multiple single point of failure problems which can result in well shutdown and which can require a coiled tubing cleanout before re-starting the fracturing operation.

### SUMMARY

In general, a system and methodology provide startup power and/or reserve power at an electric frac wellsite. According to an embodiment, an energy storage system, e.g. a battery bank, is coupled with corresponding equipment and may be mounted on an over-the-road transport, e.g. a transportable trailer or skid, for delivery to a desired wellsite. The corresponding equipment may comprise, for example, an inverter, charger, cooling system, and/or other components. Additionally, the energy storage system may be coupled with a transformer which may be mounted on the same or a different trailer or skid. The energy storage system is configured to provide sufficient power for enabling turbine generator start up and/or provision of reserve power for other wellsite activities. In some embodiments, the energy storage system, e.g. the battery bank, may be used to provide reserve power useful for improving operation of electric fracturing systems and for reducing the risk of wellsite shut down and cleanout.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a schematic illustration of an example of an electric fracturing equipment layout which includes a battery bank, according to an embodiment of the disclosure;

FIG. 2 is a schematic illustration of an example of a powertrain for an AC electric fracturing system combined with an energy storage system, according to an embodiment of the disclosure;

FIG. 3 is a schematic illustration of an example of a powertrain for a DC power distribution fracturing system combined with an energy storage system, according to an embodiment of the disclosure;

FIG. 4 is a schematic illustration of an example of a wellsite energy storage system, according to an embodiment of the disclosure; and

FIG. 5 is a schematic illustration of another example of a wellsite energy storage system, according to an embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The disclosure herein generally involves a system and methodology related to providing startup power and/or reserve power at an electric frac wellsite. The system and methodology enable alternative power for an electric frac location without incurring many of the challenges associated with diesel generators. According to an embodiment, an electric energy storage system, e.g. a battery bank, is coupled with corresponding equipment and mounted on an over-the-road transport, e.g. a transportable trailer or skid, for delivery to a desired wellsite. The corresponding equipment may comprise, for example, an inverter, charger, cooling system, and/or other components. For example, the turbine powered electric frac site may be provided with a transportable battery bank and inverter system able to provide an alternative power source.

Additionally, the battery bank may be coupled with a transformer which may be mounted on the same or a different trailer or skid. The battery bank is configured to provide sufficient power for enabling turbine generator system start up and/or provision of reserve power for other wellsite activities. By way of example, the battery bank or other energy storage system may be configured to start at least one turbine twice (both in energy and power capacity). For various turbines, this amounts to 300-500 MVA power and at least 30 kW-hr of energy. In some embodiments, the battery bank (or other energy storage system) may be used to provide reserve power useful for improving operation of electric fracturing systems and for reducing the risk of wellsite shut down and cleanout.

With appropriately chosen capacity, the energy storage system also may be used to provide power for rig up operations. Depending on the specifics of a given application, the battery bank may either be coupled solely to a low-voltage system (480 or 120 VAC) or it may be coupled to a medium voltage system. Many turbines include a transformer to enable starting of one turbine from another via the medium voltage system. However, hardware may be used to enable a similar starting procedure via a low-voltage system, e.g. 480 VAC. In both cases, one battery bank can be used to provide start up for bringing the entire turbine system online.

According to some embodiments, the energy storage system may be configured so that it can power one or more pumping units after loss of the turbine system and to provide sufficient backside power to keep the pumping units fed with fluid. The power levels of the battery bank are selected so the pump units can deliver a sufficient rate of flow to keep sand in motion in the wellbore and with sufficient pressure to overcome the formation and tubular friction. It should be noted the pressures and flows involved in operating the pumping units is substantially lower than those for fracturing.

The battery bank capacity may be chosen such that the volume of fluid delivered is sufficient to bring the sand laden fluid at surface all the way into the formation. By way of example, the power and energy used in such an operation may be on the order of 2 MW and 2 MW-hr, respectively. Both of these values are well within the capability of a portable battery bank which may be loaded on an over the road trailer for transport.

Another use for the energy storage system, e.g. battery bank, is related to grid stabilization and peaking. In a fracturing operation, the turbine system may be sized near but under the maximum power required for a given fracturing job. The battery bank system may be used to provide peaking capacity during the highest power portions of the job. In this manner, the complete turbine and battery bank system can be used in combination to deliver a higher power level without additional investment in turbines. Furthermore, turbines are generally available in relatively few size ranges so the battery bank can be used for improved adaptability to a specific power rating.

Furthermore, the combination of a turbine generator system with the energy storage system enables operation of the turbine closer to its maximum power output which generally provides a more efficient operating point. Recharging of a battery bank, for example, may be performed either when the system load is less than the turbine rating or during stage changes.

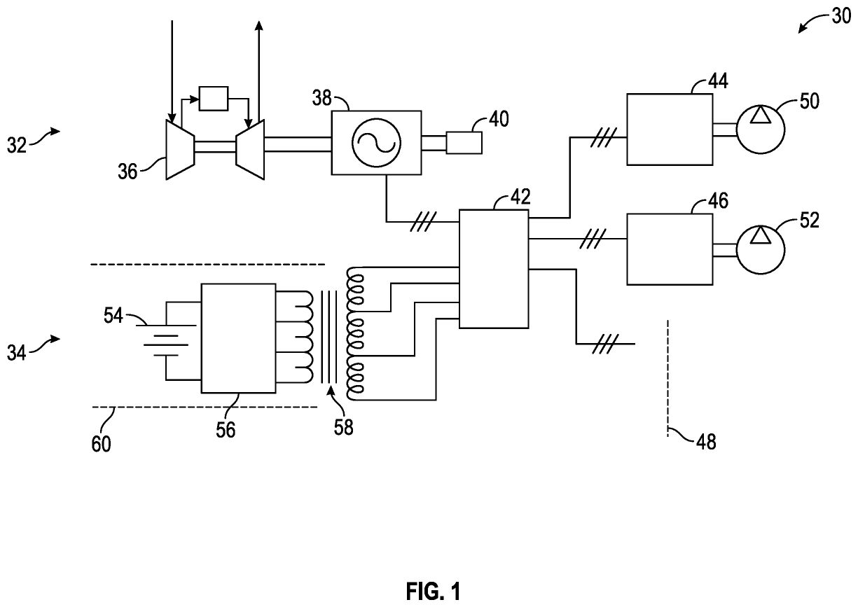

Referring generally to FIG. 1, an example of a turbine powered electric frac site system 30 is illustrated as having a turbine system 32 combined with an energy storage system in the form of a battery bank system 34. In this embodiment, the turbine system 32 comprises a gas turbine 36 coupled to a generator 38 and a starter motor 40. The output of the generator 38 feeds switchgear 42 which may include a transformer or transformers. From there, power may be delivered to drives 44, 46 and to additional systems 48. The battery bank system 34 may be configured to store sufficient energy to start the turbine system 32 at least twice.

The drives 44, 46 may each include various components, such as switchgear, transformer, variable frequency drive (VFD), and one or more motors. The drives 44, 46 each drive a corresponding pump 50, 52 respectively. The additional systems 48 may comprise added drives and pumps. Furthermore, the additional systems 48 may comprise backside systems such as blending systems, feeding systems, mixing systems, proppant handling systems, control rooms, additive systems, and/or other backside systems.

The battery bank system 34 may comprise a battery bank 54 coupled to corresponding equipment 56, e.g. inverter systems, charger systems, cooling systems, and/or other systems appropriate for a given operation. For example, equipment 56 may include an inverter to convert DC power from the battery bank 54 to AC power for the starter motor 40 (to enable starting of turbine system 32) and for other loads. Equipment 56 also may include charging electronics. In at least some embodiments, the battery bank 54 also is coupled to other powered components/systems of the overall electric frac site system 30 via a transformer 58. For example, the transformer 58 may be connected between loads and an inverter coupled to battery bank 54, although some loads may be connected directly. The battery bank 54 is transportable and may be mounted on an over the road trailer 60 or other transport system such as a skid. In some applications, the battery bank 54 and the corresponding equipment 56 are both mounted on a corresponding transport system, e.g. trailer 60, as an overall standalone unit. In some operations, this approach allows the overall system to be set up without high-voltage high current DC connections.

Depending on the parameters of a given operation, the battery bank 54 or other energy storage system may be used to establish an uninterruptible power supply to accommodate power requirements for a given fracturing operation. The energy storage system may be coupled into the overall turbine powered electric frac site system 30 and/or to specific components or systems at the frac site to provide appropriate levels of power and energy. Additionally, the battery bank system 34 may be constructed with an appropriate size to enable mounting of the battery bank system 34 on one or more over-the-road transports such as trailer 60 or a skid.

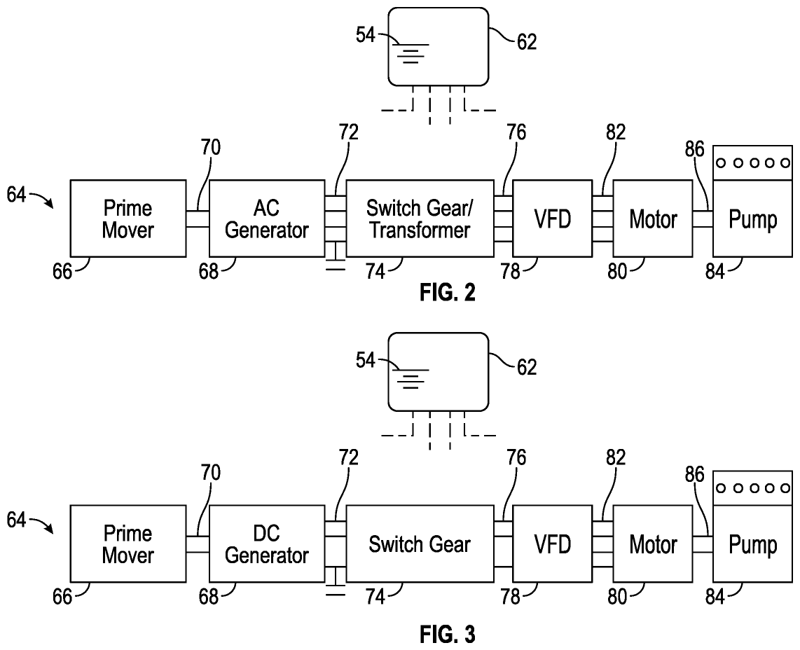

Referring generally to FIG. 2, another example of an energy storage system 62, e.g. a battery bank 54 or other suitable energy storage system, is illustrated as coupled with a powertrain 64 of an AC electric fracturing system. In this example, the powertrain 64 comprises a prime mover 66, e.g. a turbine or a diesel engine, for driving a generator 68 via a shaft 70. Suitable wiring 72, e.g. three phases plus ground, is coupled with control electronics 74, e.g. switches, circuit breakers, and sometimes transformers. One or more outputs from the electronics 74 may be coupled via cables 76 to a variable frequency drive (VFD) or drives 78. The VFDs 78 feed one or more electric motors 80 via electrical cables 82 to effectively control the corresponding frac pump 84. The one or more electric motors 80 are used to drive one or more corresponding pumps 84 via shaft(s) 86.

In this type of overall fracturing system 30, the energy storage system 62 may be used to extract and supply energy at multiple points to accomplish different objectives. For example, the energy storage system 62 may be used to provide electrical power for enabling startup of the prime mover 66. Additionally, extraction may be used to collect and store energy in system 62 when there is an available surplus and such energy extraction can be achieved by coupling energy storage system 62 at, for example, wiring 72 and/or cables 76. The energy storage system 62 may be an AC output energy storage system used to feed power into the system at, for example, wiring 72, control electronics 74, and/or cables 76. In some applications, power could be fed into the system at electrical cables 82 using, for example, a transfer switch to enable selection of the desired corresponding motors 80 and pumps 84. If energy storage system 62 is a DC output energy storage system, the system can feed energy directly into the capacitor bank(s) of VFD(s) 78.

Although energy storage system 62 is described above as comprising battery bank 54, the energy storage system 62 also may comprise other types of devices. For example, the energy storage system 62 may comprise flywheels, super capacitors, fuel cells, compressed gases, and various combinations of systems with or without batteries. In some applications, the energy storage system 62 may be configured in the form of a one-shot backup power system similar to hydraulic accumulators used for blowout preventer (BOP) control systems. Sources for such one-shot electrical power comprise primary cells, fuel cells, and energetic chemical reactions.

Referring generally to FIG. 3, an example of energy storage system 62, e.g. battery bank 54, is illustrated as coupled with another type of powertrain 64 used in an electric fracturing system. In this example, the powertrain 64 is for a DC distribution system and comprises prime mover 66 coupled to generator 68 via shaft 70. According to this embodiment, the generator 68 may generate DC directly or may generate AC and have it rectified to produce DC. The DC generator 68 is coupled to control electronics 74, e.g. switchgear and protective gear via suitable wiring 72, e.g. cables. The cable/wiring 72 may be separated into one conductor (plus or minus voltage) or two conductors (plus and minus voltage) combined with a power return wire and a safety ground. Outputs from the control electronics 74 feed one or more VFDs 78 via cables 76. The one or more VFDs 78 feed one or more electric motors 80 via electrical cables 82, e.g. three or more phases and ground. The one or more electric motors 80 drive one or more corresponding pumps 84 via shaft(s) 86.

It should be noted that having a plurality of electrical phases, e.g. more than three phases, may be useful in motor and VFD design to reduce power levels per phase and offer fault tolerance. Having positive and negative voltages with respect to ground may be useful in reducing the insulation otherwise required. In the example illustrated in FIG. 3, energy may be extracted by energy storage system 62 at, for example, wiring 72, switchgear/control electronics 74, cables 76, and sometimes at locations within the VFDs 78. Energy may be injected from energy storage system 62 back into the overall powertrain 64 at, for example, wiring 72, switchgear/control electronics 74, cables 76, and sometimes at locations within the VFDs 78. As with other embodiments, the energy storage system 62 may be used to provide electrical power for enabling startup of the prime mover 66. It should be noted that the cables and wiring may be in the form of physical cables but use of the “cable” terminology also is meant to cover busbars, electrical sockets, flexible interconnects, and other types of conductive pathways.

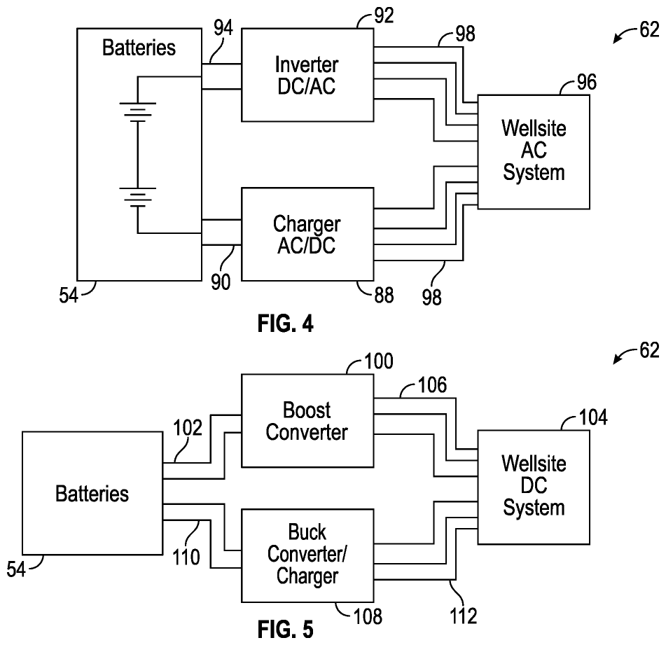

Referring generally to FIG. 4, another example of one type of energy storage system 62 is illustrated. In this example, the energy storage system 62 comprises battery bank 54. The battery bank 54 may be coupled with a charger 88 which converts AC power to DC for the batteries and battery bank 54 while also controlling both charging and balancing of the battery bank 54 via suitable cables or other conductors 90. Additionally, the battery bank 54 may be coupled with one or more inverters 92 which take energy from the battery bank 54 via suitable cables or other conductors 94 and supply the energy to the wellsite system 96, e.g. powertrain 64, via suitable cables or other conductors 98. Similar cables/conductors 98 may be used to connect the charger 88 with the wellsite system 96. Such an overall energy storage system may be configured to feed energy to an active system at the frequency and phase of the active system.

Referring generally to FIG. 5, another example of energy storage system 62 is illustrated. In this example, the energy storage system 62 is a DC link storage system and comprises battery bank 54. The battery bank 54 may be coupled with a boosting converter 100 via cables or other suitable conductors 102 and the boosting converter 100 may be used for increasing voltage. A boost topology is an example of one construction of a switching converter. However, other converters may be able to provide bi-directional power flow by combining the forward and reverse conversion into one device. The boost converter 100 feeds current into a wellsite DC system 104 via suitable cables or other conductors 106. Frequency or phase may not have to be regulated, but excessively high or low voltages should be avoided in some systems. This may be regulated by either regulating current to maintain a bus voltage (which may be variable) or by communicating with the loads to determine the power flow required. Similar to the AC system described above, a charging and balancing system 108 may be coupled between the battery bank 54 and the wellsite DC system 104 via suitable cables or other conductors 110, 112, respectively.

In wellsite systems where a single prime mover 66 is used, the energy storage system 62 may be selected so that it can provide sufficient power and energy to flush the well. In some applications, however a smaller energy storage system 62 may be selected to serve as a backup which may be started to provide some of the power used in a given wellsite system. However, in wellsite systems where multiple prime movers 66 are used, the backup energy storage system 62 may be selected with sufficient capability to address the loss of one of the prime movers 66 for a suitable time period to either finish a stage or to flush the well. The energy storage system 62 also may be sized to supply sufficient power and energy to flush the well at low speed in the event of an overall loss of the multiple prime movers 66 due to, for example, fuel loss.

The energy storage system 62 also may be constructed and used in providing “black start” capability for one or more prime movers 66. In this capacity, the energy storage system 62 provides both energy and power for a desired number of starts, e.g. at least two starts provided on stored power. For wellsite applications, the energy storage system 62 is constructed for transportability and ease of use. According to an example, a given energy storage system 62 may be sized for transport on one or two over-the-road trailers 60, e.g. over the road air ride suspension type trailers. Various vibration and shock detection devices may be used to protect the battery bank 54 and/or other equipment associated with energy storage system 62 during transport.

Components on separate over the road trailers may have various electric couplings designed to minimize cables on the ground. Additionally, cooling units may be incorporated into the trailer system to provide circulating water or other coolant for the energy storage system 62. Furthermore, various physical interlocks may be used to separate the battery bank 54 into sections and to limit the potential for unwanted energy discharge.

It should be noted the configuration of fracturing system 30, turbine system 32, battery bank system 34, energy storage system 62, and other systems and components may be adjusted according to the parameters of a given fracturing operation. Various additional and/or other components may be incorporated into the overall system to accommodate parameters of a specific fracturing operation. The energy utilized in a given fracturing system or portions of a given fracturing system may change which may encourage different types and sizes of energy storage system 62, e.g. different battery banks 54.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A system for use in fracturing a well, comprising:
a fracturing system including:
a frac pump powered by an electric frac pump motor;
a turbine system having a generator coupled to a turbine and a startup motor, the generator providing electrical power for the electric frac pump motor; and
a battery bank system comprising a battery bank having sufficient power for enabling startup of the turbine system, the battery bank being mounted on an over-the-road transport.

2. The system as recited in claim 1, wherein the fracturing system further comprises a variable frequency drive (VFD) for controlling the frac pump.

3. The system as recited in claim 1, wherein the fracturing system further comprises a transformer coupled to the battery bank.

4. The system as recited in claim 1, wherein the battery bank has sufficient power to start the turbine system at least twice.

5. The system as recited in claim 1, wherein the battery bank is coupled to selected fracturing system components to provide reserve power.

6. The system as recited in claim 1, wherein the battery bank provides power for rig up operations.

7. The system as recited in claim 1, wherein the battery bank is coupled to at least one electric frac pump motor in a manner to provide power for pumping if the turbine system stops functioning.

8. The system as recited in claim 1, wherein the battery bank provides grid stabilization.

9. The system as recited in claim 1, wherein the generator is coupled to switchgear.

10. The system as recited in claim 1, wherein the battery bank is coupled into the fracturing system as an uninterruptible power supply.

11. A system for use in fracturing a well, comprising:
a fracturing system comprising:
an energy storage system mountable on an over-the-road transport; and
a power train, the powertrain including:
a frac pump;
an electric motor coupled to the frac pump;
a variable frequency drive (VFD) coupled to the electric motor;
a generator;
switchgear connected between the generator and the VFD; and
a prime mover coupled to the generator, the energy storage system being operationally connected with the powertrain at a plurality of locations to selectively extract energy from and feed energy to the powertrain.

12. The system as recited in claim 11, wherein the energy storage system comprises a battery bank.

13. The system as recited in claim 11, wherein the generator comprises an AC generator.

14. The system as recited in claim 11, wherein the generator comprises a DC generator.

15. The system as recited in claim 11, wherein the battery bank is coupled with circuitry for converting AC power to DC.

16. The system as recited in claim 11, wherein the energy storage system comprises a DC link storage system.

17. A method, comprising:
providing a fracturing system with a frac pump powered by an electric motor;
coupling a generator to the electric motor to power the electric motor;
using a prime mover to operate the generator; and
enabling startup of the prime mover with electrical power provided from an electrical energy storage system.

18. The method as recited in claim 17, further comprising mounting the electrical energy storage system on an over-the-road transport.

19. The method as recited in claim 18, further comprising forming the electrical energy storage system as a battery bank.

20. The method as recited in claim 19, further comprising constructing the prime mover as a turbine with a startup motor.
